(19) United States
(12) Patent Application Publication
(10) Pub. No.: US 2012/0244918 A1
(43) Pub. Date: Sep. 27, 2012

(54) Cell Phone Case

(76) Inventor: Kimberly S. Hall, Johns Creek, GA (US)

(21) Appl. No.: 13/415,019

(22) Filed: Mar. 8, 2012

Related U.S. Application Data
(60) Provisional application No. 61/464,849, filed on Mar. 10, 2011.

(51) Int. Cl. H04W 88/00

(52) U.S. Cl. 455/575.4; 455/575.1

(57) ABSTRACT

An improved cell phone case having a reflective device and a storage compartment for other items.

### REFERENCE TO RELATED APPLICATION

This application claims the benefit of U.S. Provisional Patent Application Serial No. 61/464,849, filed Mar. 10, 2011.

### TECHNICAL FIELD

This invention relates to an improved cell phone case. In a more specific aspect, this invention relates to a cell phone case which contains a reflective device and a storage compartment.

In this application, the terms “storage compartment” and “reflective device” shall have the following definitions:

“Storage compartment” will be understood to refer to an area which is part of the cell phone case and which can be used to hold or store items, such as a driver's license. credit card. debit card, reflective device, etc.

“Reflective device” will be understood to refer to any material having a reflective surface. Examples of such materials are mirrors; certain plastic materials. such as polycarbonates and acrylics: glass materials; glass-type materials; etc.

For ease of reference, this invention will be described with regard to a mirror and a credit card.

### BACKGROUND OF THE INVENTION

Cell phones and cases (or covers) for cell phones are well known in the communications industry. However, many times a cell phone user will need a mirror (such as for checking appearance before a meeting) and/or a storage compartment for holding certain items.

Therefore, there is a need for an improved and more useful cell phone case.

### SUMMARY OF THE INVENTION

Briefly described, this invention provides a cell phone user with a case for the cell phone in which the case contains a mirror and a storage compartment.

The features and advantages of this invention will become apparent from the following detailed description.

### BRIEF DESCRIPTION OF THE DRAWINGS

FIG. 1 shows a side view of an embodiment of the cell phone case of this invention in an open position so that the credit card can be removed from the storage compartment and the mirror slides up for use.

FIG. 2 shows a front view of the cell phone case of FIG. 1.

FIG. 3 shows a side view of an embodiment of the cell phone case of this invention in a closed position so that the credit card is in the storage compartment and the mirror moved down to be covered.

FIG. 4 shows a back view of the cell phone case of FIG. 3.

### DETAILED DESCRIPTION OF THE INVENTION

The present invention provides a cell phone case having a reflective device and a storage compartment. The reflective device can be located in the storage compartment. This invention provides a cell phone case comprising:
(a) a rigid container comprised of jointable front, back and side portions:
(b) a compartment integral with the back portion of the rigid container.
   wherein the compartment is opened and closed with a slidable cover; and
(c) a space located in the compartment and adapted to hold at least one item.

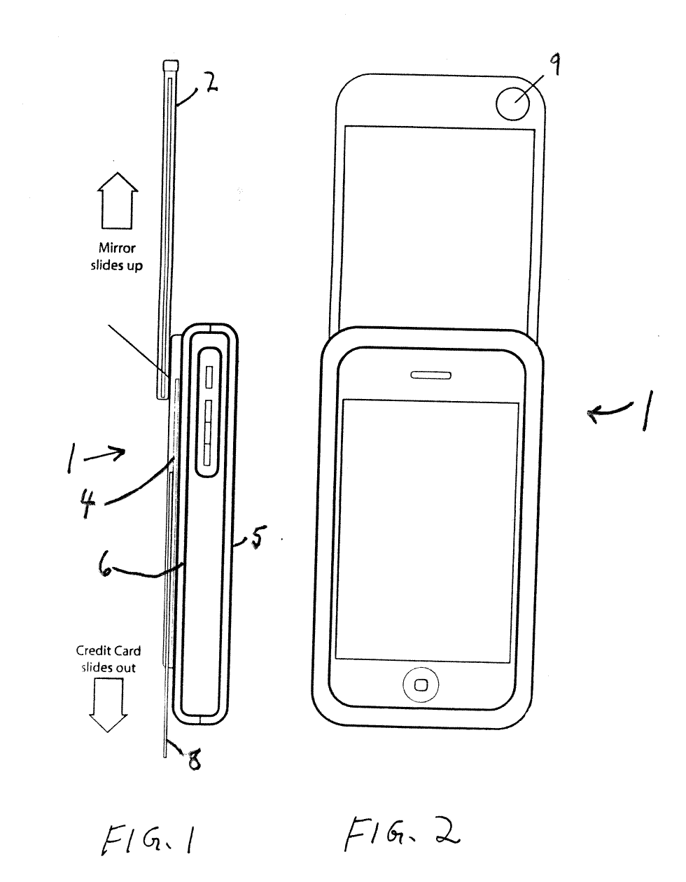

Preferred embodiments of this invention are shown in FIGS. 1-4.

Referring now to the drawings, in which like numbers represent like elements. FIG. 1 shows a side view of the cell phone case 1 of this invention in an open position. The mirror 2 (reflective device) has been moved out to the open position. Mirror 2 is attached to the inside portion of slidable cover 3. Storage compartment 4 is closed when mirror 2 is moved down to the closed position.

The cell phone case 1 shown in FIG. 1 is comprised of front portion 5, back portion 6 and side portion 7 (not shown), which are joined by a friction fit. (These portions of the cell phone case can be joined by other means, such as by use of an adhesive or glue material.)

For FIG. 1. when the slidable cover 3 is moved to the open position to expose mirror 2, credit card 8 slides (or can he removed) from storage compartment 4.

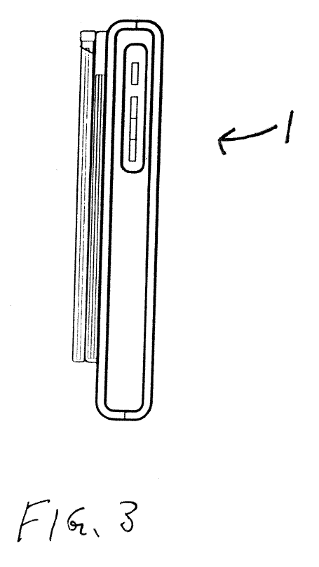

FIG. 2 shows a front view of the cell phone case 1 (shown in FIG. 1) with slidable cover 3 and aperture 9. When slidable cover 3 is in the closed position (i.e., mirror 2 is not exposed), aperture 9 will be positioned to not interfere with the camera function (if present) of the cell phone.

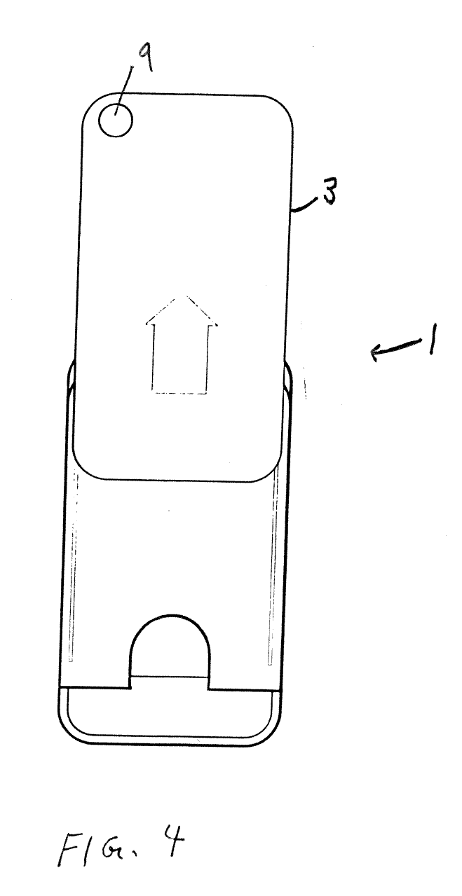

With reference to FIG. 3, cell phone case 1 is shown in the closed position so that credit card 8 is located in storage compartment 4, and mirror 2 is not exposed.

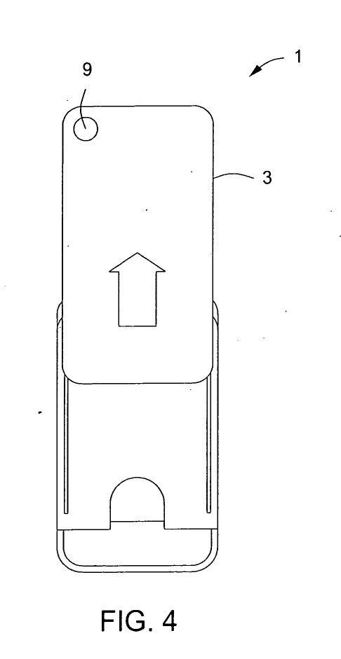

FIG. 4 shows a back view of cell phone case 1 in which slidable cover 3 is in the open position, and aperture 9 is not in cooperation with the camera function (not shown) of the cell phone.

In this invention, the mirror must not interfere with the camera function of the cell phone. Thus, the mirror must be smaller than the outside dimensions of the cell phone case. Additionally, the storage compartment must not interfere with the camera function of the cell phone and must be smaller than the outside dimensions of the cell phone case.

As can be seen from FIGS. 1-4, the mirror and storage compartment (holding the credit card) are exposed when the back is opened. Both the slidable cover and storage compartment are integrated into the cell phone case of this invention.

There are many models of cell phones, and each model most likely will have a case to fit that model. The cases can have many different dimensions and may be square, rectangular etc., in shape. The cell phone case of this invention can be sized and configured to work with these various models of cell phones.

The rigid cell phone case can be constructed of different materials, such as leather, a hard molded plastic material, artificial leather (such as naugahyde), vinyl, a rubber material, silicon, a woven textile, a fabric, etc.

This invention allows a cell phone user o eliminate the necessity to carry a mirror, a credit card and the cell phone as separate units.

The invention has been described in detail with particular reference to certain embodiments, but variations and modifications of these embodiments can be made without departing from the spirit and scope of the invention.

1. A case for a cellular telephone, wherein the case comprises:
(a) a rigid container comprised of joinable front, back and side portions;
(b) a compartment integral with the back portion of the rigid container, wherein the compartment is opened and closed with a slidable cover; and
(c) a space located in the compartment and adapted to hold at least one item.

2. A case as defined by claim 1, wherein the rigid container is formed from a plastic material.

3. A case as defined by claim 1, where the rigid container is formed from an artificial material.

4. A case as defined by claim 1, wherein the front, back and side portions are joined by a friction fit.

5. A case as defined by claim 1, wherein the front, back and side portions are joined by an adhesive material.

6. A case as defined by claim 1, wherein the item located in the space is a reflective device.

7. A case as defined by claim 6, wherein the reflective device is a mirror.

8. A case as defined by claim 1, wherein the item located in the space is a credit or debit card.

9. A case as defined by claim 1, wherein the slidable cover has an aperture.

10. A case as defined by claim 1, wherein the slidable cover has an inside portion and an outside portion.

11. A case as defined by claim 10, wherein a reflective device is attached to the inside portion of the slidable cover.
